(19) United States
(12) Patent Application Publication
(10) Pub. No.: US 2011/0273777 A1
(43) Pub. Date: Nov. 10, 2011

(54) Lens barrel

(75) Inventors: Takashi Koyama, Tokyo (JP); Kiyomitsu Furuyama, Kanagawa (JP)

(73) Assignee: Sony Corporation, Tokyo (JP)

(21) Appl. No.: 13/064,732

(22) Filed: Apr. 12, 2011

(30) Foreign Application Priority Data
May 10, 2010 (JP) 2010-108800
May 10, 2010 (JP) 2010-108802

(51) Int. Cl. G02B 7/02

(52) U.S. Cl. 359/611; 359/823

(57) ABSTRACT

A lens barrel includes: a barrel ring fixedly or movably supporting a plurality of lenses arrayed in an optical axis direction; a first holding ring movably holding the barrel ring in the optical axis direction; an operating ring rotatably supported by the first holding ring; a second holding ring which prevents the operating ring from coming loose, by bayonet engagement with the first holding ring; and a stopper pin, which is introduced between the first holding ring and the second holding ring, to prevent relative rotational displacement.

### BACKGROUND OF THE INVENTION

1. Field of the Invention

The present invention relates to a lens barrel with an operating ring rotatably supported by a holding ring and to an imaging apparatus having the lens barrel, and more particularly relates to an attaching structure of the holding ring to prevent the operating ring from coming loose.

2. Description of the Related Art

With lens barrels such as exchangeable lenses or the like used with imaging apparatuses such as digital still cameras or the like, operating rings such as a focus operating ring, zoom operating ring, and so forth, are used in a state of being rotatable as to a first holding ring. This sort of operating ring is generally assembled from one side in the optical axis direction as to the first holding ring, and a later-assembled second holding ring is screwed by screws to the first holding ring, thereby preventing the operating ring from coming loose from the first holding ring. At this time, in order to prevent the screw from being exposed to sight in an unsightly manner, improvement in external appearance is often undertaken such as covering with a rubber outer cover, a sealing member, or the like.

An example of such a lens barrel according to the related art is described in Japanese Unexamined Patent Application Publication No. 2-170002, for example. Japanese Unexamined Patent Application Publication No. 2-170002 describes a lens barrel using a position detecting device for detecting the position of focusing, zooming, and so forth, of an exchangeable lens. The position detection device according to the lens barrel described in this Japanese Unexamined Patent Application Publication No. 2-170002 has an electroconductive pattern for position detection, and multiple brushes which slide across the electroconductive pattern and to which lead lines are connected. A feature is that the configuration is such that, of the multiple brushes, the sliding face of at least one brush shares a part of the sliding face of another brush.

According to a position detection device having such a configuration (hereinafter referred to as “first example of the related art”), by the sliding face of at least one brush sharing a part of the sliding face of another brush, the brushes can be reduced in size and width. Further, an anticipated advantage is that the electroconductive pattern can also be reduced in size and width (section of Advantages in Japanese Unexamined Patent Application Publication No. 2-170002).

Another example of such a lens barrel according to the related art is described in Japanese Unexamined Patent Application Publication No. 2004-94052, for example. Japanese Unexamined Patent Application Publication No. 2004-94052 describes a lens barrel having a transmitted light adjusting unit, using a physical property element capable of adjusting transmitted light. The lens barrel according to this Japanese Unexamined Patent Application Publication No. 2004-94052 relates to an optical system where spherical aberration and the like readily occur due to change in incident ray height corresponding to change in focal position or focal distance. A feature is that the lens barrel has a transmitted light adjusting unit using a physical property element of which the light transmission region is divided into multiple regions, with the unit changing the operating region of the transmission region divided into multiple regions, corresponding to the change in focal position or focal distance.

A lens barrel having such a configuration (hereinafter referred to as “second example of the related art”) has a transmitted light adjusting unit using a physical property element of which the light transmission region is divided into multiple regions. Accordingly, an anticipated advantage is that a diaphragm device for removing undesirable light, which conserves space and is less restrictive regarding design, can be realized (paragraph [0039] in Japanese Unexamined Patent Application Publication No. 2004-94052).

However, in the case of the first example of the related art, the structure is such that a fastening ring for nipping a dustproof sheet is placed at the tip of the barrel proper, and the fastening ring is fixed to the barrel proper by being constricted by screws from the outer side in the diameter direction. Accordingly, screws are externally exposed, which is unsightly. There is a method which is a measure to improve this, in that the heads of the screws are covered with an outer cover formed of rubber so as to prevent the screw heads from being externally exposed, thereby preventing the external appearance from being poor. However, this measure is not readily employed in the event that using rubber as an outer cover or covering the screw heads with seal members or the like is unnatural from a design perspective. Also, in the case of using screws for fixing, the diameter of the screw receptacle portion should have, in addition to the diameter of the screw, a corresponding thickness at the female screw side, leading to a problem in that this portion has to be thick, and accordingly the overall size increases. Also, fixing the fastening ring using adhesive agent instead of using screws is problematic in that the fastening ring is not capable of being disassembled thereafter.

Also, in the case of the second example of the related art, while no screws are shown in FIG. 1 and so forth of Japanese Unexamined Patent Application Publication No. 2004-94052, there are shown holes for screws to engage, and the arrangement is disclosed such that a state in which a first group barrel is fixed to the tip of a linear-drive barrel. With this related art, a cover is disposed in front of the screws covering the screw heads with the cover. Accordingly, the screw heads are not exposed to external view, and poor external appearance is prevented. As a result, there has been the problems of having used screws for fixing with the case of this second example of the related art as well, as with the case of the first example of the related art.

### SUMMARY OF THE INVENTION

With lens barrels according to the related art, the structure is such that the fastening ring is fixed to the barrel proper by screws, with the screw heads being exposed which makes for poor external appearance. Accordingly, improvement in appearance can be made by positioning a rubber outer cover as a separate member or with a seal member or the like, but this is problematic since not only does the number of parts increase, but also the overall product becomes greater in size. Also, in the case of fixing the fastening ring with an adhesive agent, the fastening ring is not capable of being disassemble thereafter, which is problematic as this interferes with maintenance.

A lens barrel according to an embodiment of the present invention includes: a barrel ring fixedly or movably supporting a plurality of lenses arrayed in an optical axis direction; a first holding ring movably holding the barrel ring in the optical axis direction; an operating ring rotatably supported by the first holding ring; a second holding ring which prevents the operating ring from coming loose, by bayonet engagement with the first holding ring; and a stopper pin, which is introduced between the first holding ring and the second holding ring, to prevent relative rotational displacement.

An imaging apparatus according to an embodiment of the present invention includes a lens barrel having a plurality of lenses; and an imaging apparatus to which the lens barrel is detachably mounted; the lens barrel including a barrel ring fixedly or movably supporting a plurality of lenses arrayed in an optical axis direction, a first holding ring movably holding the barrel ring in the optical axis direction, an operating ring rotatably supported by the first holding ring, and a second holding ring which prevents the operating ring from coming loose, by bayonet engagement with the first holding ring; wherein a stopper pin is introduced between the first holding ring and the second holding ring, to prevent relative rotational displacement.

With the lens barrel of the above-described configuration, the second holding ring can be fixed to the first holding ring without using screws or adhesive agent and disassembly work thereof and be performed easily, and also the operating ring can be prevented from coming loose in a sure manner.

### BRIEF DESCRIPTION OF THE DRAWINGS

FIG. 1 illustrates an example of a lens barrel according to an embodiment of the present invention, and is an external perspective view of the lens barrel in a retracted state;

FIG. 2 is a side view of the retracted state of the lens barrel shown in FIG. 1;

FIG. 3 is a front view of the lens barrel shown in FIG. 1;

FIG. 4 is an explanatory diagram where a cross-section of a primary portion of the lens barrel shown in FIG. 2 is enlarged;

FIG. 5 is a side view of an extended (zoom) state of the lens barrel shown in FIG. 1;

FIG. 6 shows a state of a lens hood being mounted to the lens barrel in FIG. 5, and is an external perspective view illustrating an example of the lens barrel according to an embodiment of the present invention;

FIG. 7 illustrates an example of the lens barrel according to an embodiment of the present invention, and is an explanatory diagram with the upper half of the lens barrel cut away;

FIG. 8 is an enlarged cross-sectional view of a primary portion of the lens barrel shown in FIG. 7, and is an explanatory diagram of when forward mounting the lens hood;

FIG. 9 is an enlarged cross-sectional view of a primary portion of the lens barrel shown in FIG. 7, and is an explanatory diagram of when reverse mounting the lens hood;

FIG. 10 is a side view of a reverse mounting state of the lens hood to the lens barrel shown in FIG. 1;

FIG. 11 is a front view of a reverse mounting state of the lens hood to the lens barrel shown in FIG. 1;

FIG. 12 is an explanatory diagram with a portion of the lens barrel shown in FIG. 1 where a stopper pin is mounted is cut away;

FIG. 13 is an explanatory diagram externally viewing a primary portion of a fixing holding ring where a stopper pin of the lens barrel shown in FIG. 1 is mounted;

FIG. 14 is an external perspective view of a front holding ring relating to the lens barrel shown in FIG. 1;

FIG. 15 is an explanatory diagram showing a portion where the stopper pin of the lens barrel shown in FIG. 1 is mounted, cut away in a direction orthogonal to the optical axis;

FIG. 16 is a perspective view of a portion where the stopper pin of the lens barrel shown in FIG. 1 is mounted;

FIGS. 17A through 17E illustrate the stopper pin relating to the lens barrel, wherein FIG. 17A is a perspective view, FIG. 17B is a front view, FIG. 17C is a left side view, FIG. 17D is a plan view, and FIG. 17E is a bottom view;

FIG. 18 is an explanatory diagram illustrating a state of mounting the stopper pin to a pin mounting portion relating to the lens barrel in FIG. 1;

FIG. 19 is an explanatory diagram illustrating a state of the stopper pin mounted to the pin mounting portion relating to the lens barrel in FIG. 1;

FIG. 20 is an explanatory diagram illustrating a state of removing the stopper pin mounted to the pin mounting portion relating to the lens barrel in FIG. 1; and

FIG. 21 is an external perspective view of a digital still camera according to an embodiment of the present invention, illustrating an example of an imaging device having the lens barrel shown in FIG. 1.

### DESCRIPTION OF THE PREFERRED EMBODIMENTS

A stopper pin is introduced between a first holding ring and a second holding ring, and relative rotational displacement of the first holding ring and second holding ring is prevented by the stopper pin. Thus, the second holding ring can be fixed to the first holding ring with the stopper pin without using screws, and lens barrel and imaging apparatus regarding which assembly and disassembly work can be easily performed is realized with a simple configuration.

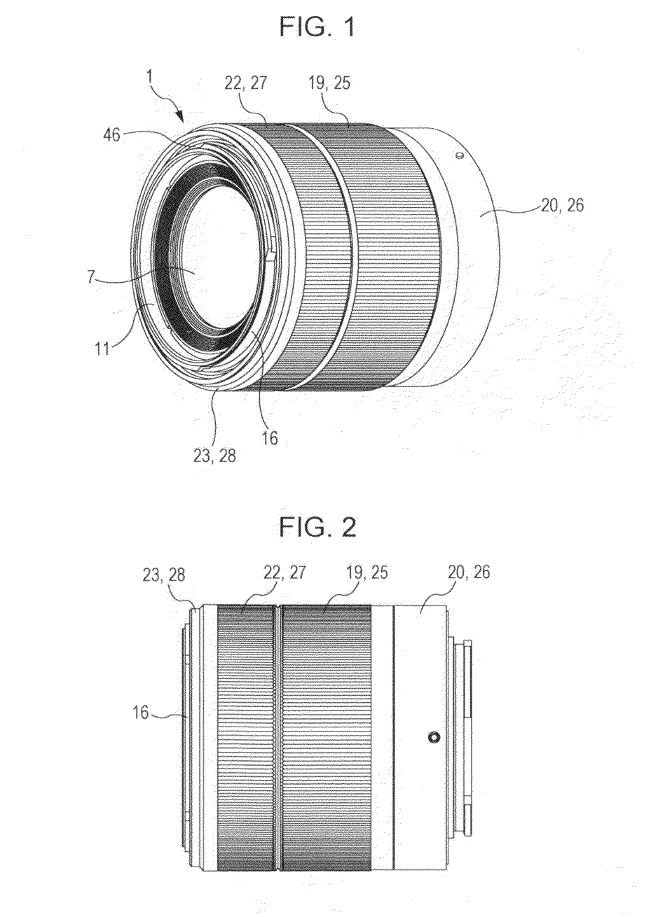

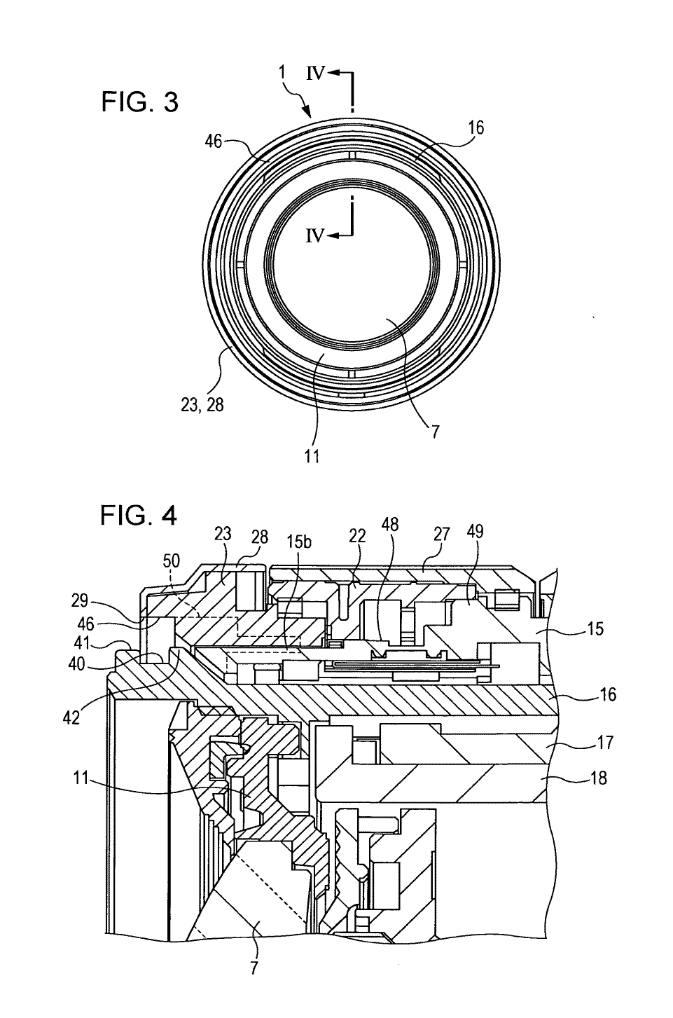

Embodiments of the present invention will be described with reference to the appended drawings. In the Present Application, a combination of a lens barrel (exchangeable lens) 1 shown in FIGS. 1 through 5 and an imaging apparatus main unit (camera body main unit) 4 will be defined as an imaging apparatus 5.

### First Embodiment

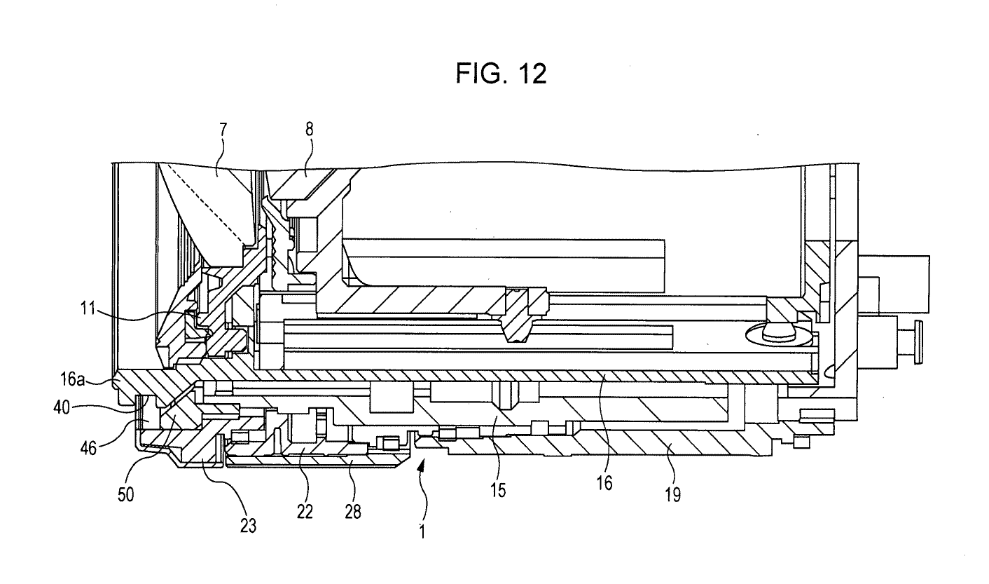

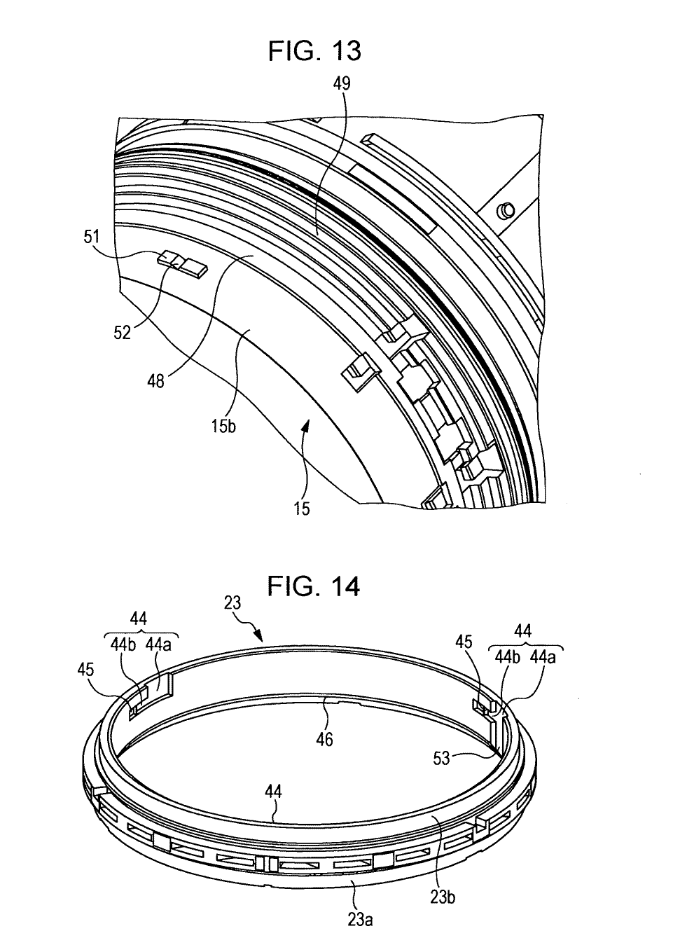

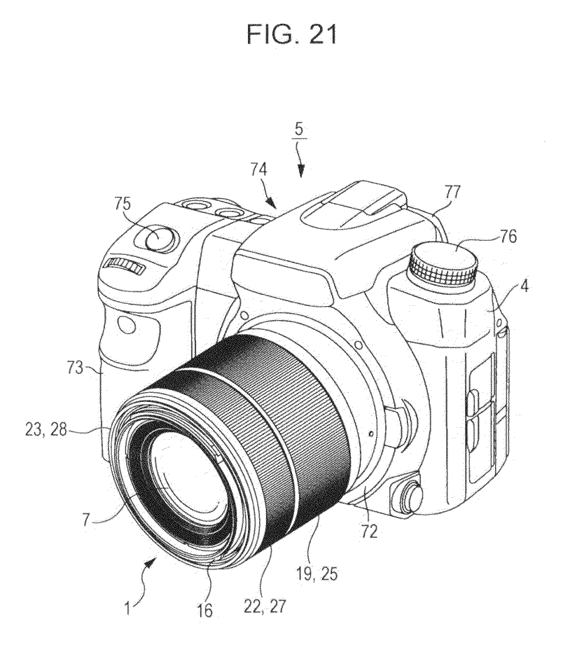

FIGS. 1 through 20 illustrate a lens barrel 1 according to a first embodiment of the present invention. The lens barrel 1 is configured as an exchangeable lens used with a single-lens reflex type digital still camera (hereinafter referred to as “digital still camera”.). As shown in FIG. 21, the lens barrel 1 is coupled with the camera body main unit 4 which is an illustration of a specific example of a imaging apparatus main unit, so as to configure a digital still camera 5 which is an illustration of an imaging apparatus. The lens barrel 1 and camera body main unit 4 each have control circuits, and images can be photographed while performing supply of power source and transmission of image signals via unshown electrical contacts.

The lens barrel 1 is configured of a photography optical system configured of optical elements such as multiple lenses and filters and the like, a mechanical system of rings and frames and the like which fixedly or movably support the components of the photography optical system, and an unshown control circuit. The mechanical system of the lens barrel 1 is operated by manual operations, but a configuration may be made wherein a power system such as motors and gears and the like are provided, so as to automatically operate the mechanical system.

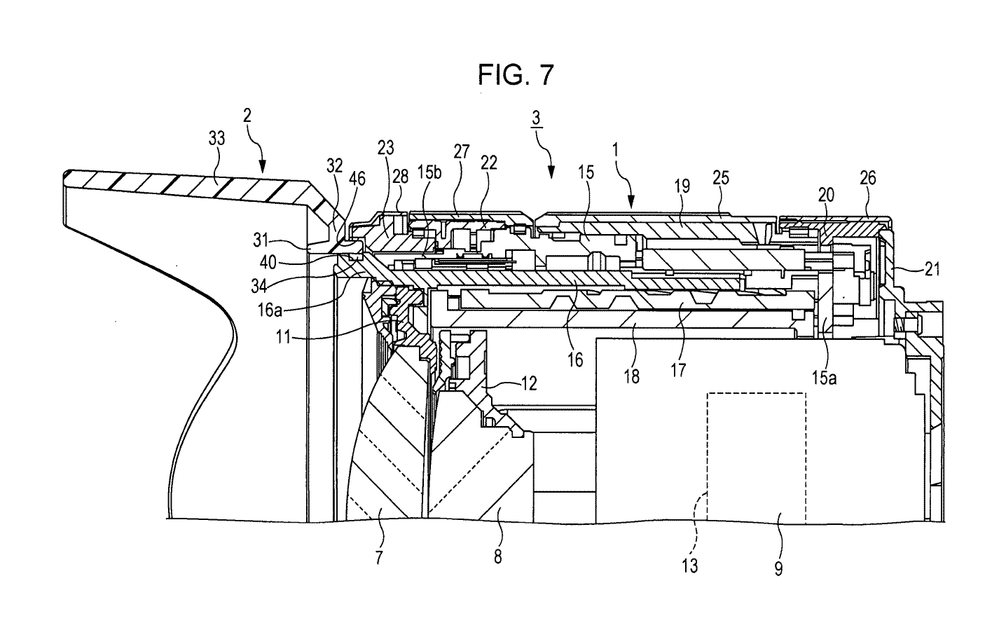

As shown in FIG. 7, the photography imaging system of the lens barrel 1 is configured of the three lens groups of a first lens group 7, a second lens group 8, and a third lens group 9. The first lens group 7 is held by a first group moving frame 11, the second lens group 8 is held by a second group moving frame 12, and the third lens group 9 is held by a third group moving frame 13.

As shown in FIG. 7, the mechanical system of the lens barrel 1 includes a fixed holding ring 15, a barrel ring 16, a zoom cam ring 17, a fixed tube 18, a zoom operating ring 19, a rear holding ring 20, a mount ring 21, a focus operating ring 22, a front holding ring 23, and so forth. The fixed holding ring 15 illustrates a specific example of a first holding ring, and is a tubular member serving as framework of the mechanical system, with an inner flange portion 15a disposed on the inner side in the radial direction provided on one end in the axial direction. The mount ring 21 is fixed on the outer face of the inner flange portion 15a of the fixed holding ring 15, by unshown screws. The lens barrel 1 is detachably mounted in bayonet fashion to the imaging apparatus main unit 4 by way of this mount ring 21.

The barrel ring 16 which is tubular is disposed on the inner side of the fixed holding ring 15, the zoom cam ring 17 which is tubular is disposed on the inner side of the barrel ring 16, and the fixed tube 18 which is tubular is disposed on the inner side of the zoom cam ring 17. The fixed tube 18 is fixed to the inner face of the inner flange portion 15a by unshown screws, so that the zoom cam ring 17 is rotatably supported on the outer circumference of the fixed tube 18. The zoom cam ring 17 does not move in the axial direction (same as optical axis direction) (no feeding out), and is only capable of rotating. The zoom cam ring 17 is provided with multiple cam grooves for moving the first lens group 7 and second lens group 8 and third lens group 9 to predetermined positions.

Though not shown in the drawings, a cam pin provided to the barrel ring 16 is engaged with one of the multiple cam grooves of the zoom cam ring 17. An axial direction groove extending in the axial direction is provided to the barrel ring 16, and a guide pin is slidably engaged with the axial direction groove. The guide pin is erected on the outer face of the fixed tube 18, and the guide pin is slidably engaged with the axial direction groove. Accordingly, rotating the zoom cam ring 17 causes rotation of the zoom cam ring 17 at the set position thereof, without moving in the optical axis direction. At this time, the barrel ring 16 is moved in the optical axis direction without rotating. Also, a linear-drive guide groove extending in the axis direction is provided to the fixed tube 18, with a structure such that the second group moving frame 12 and third group moving frame 13 move to predetermined positions by being guided by the linear-drive guide groove.

The zoom operating ring 19 which is tubular and has a predetermined length in the optical axis direction, and the focus operating ring 22 which is ring-shaped and also has a predetermined length in the optical axis direction, are rotatably fit on the outer side of the fixed holding ring 15. The zoom operating ring 19 is disposed on the inner flange portion 15a side of the fixed holding ring 15, with a zoom operating ring cover 25 which continues in the circumferential direction being fixed on the outer face thereof by adhesion. The zoom operating ring 19 can move in an interlocked manner with the zoom cam ring 17 by way of an unshown interlocking pin, so that the zoom cam ring 17 is driven rotationally at the same speed as the rotational speed of the zoom operating ring 19. Performing rotational operations of the zoom operating ring 19 at the set position moves the first lens group 7 through third lens group 9 to predetermined positions by way of the actions of the zoom cam ring 17, thereby enabling zoom operations.

The rear holding ring 20 having a ring shape is introduced between the zoom operating ring 19 and the mount ring 21. The rear holding ring 20 is fixed to the fixed holding ring 15, and a rear outer cover 26 which continues in the circumferential direction being fixed on the outer face of the rear holding ring 20 by adhesion.

The focus operating ring 22 illustrates a specific example of an operating ring, being disposed on the opposite side as to the inner flange portion 15a side of the fixed holding ring 15, with a focus operating ring cover 27 which continues in the circumferential direction being fixed on the outer face thereof by adhesion. The rotational angle and number of rotations of the focus operating ring 22 can be detected by an unshown position detector, and focusing operations are performed based on detection signals detecting the rotational position of the focus operating ring 22 that are output from the position detector. That is to say, the control device supplies control signals to an electric motor provided within the third lens group 9 based on the detection signals output from the position detector, and moves some of the lenses within the third lens group 9 in the optical axis direction. Thus, the focusing operations of the lens barrel 1 can be performed.

In a state of being mounted to the fixed holding ring 15, the focus operating ring 22 is in a state of being extracted to the subject side which is one side in the axial direction, so extraction thereof to the subject side is prevented by the front holding ring 23. The front holding ring 23 illustrates a specific example of a second holding ring, and is formed as a ring-shaped member which can be fit to the outer side of a tip portion 15b of the fixed holding ring 15 at the subject side, capable of engagement/separation therewith in bayonet fashion. A front outer cover 28 which continues in the circumferential direction is fixed on the outer face of the front holding ring 23 by adhesion. A through hole 29 having a size around the same as that of the diameter of a later-described hood end storing unit 46 of the front holding ring 23 is provided at the end face portion of the front outer cover 28. A tip portion 16a of the barrel ring 16 faces the inner side of the tip portion 15b of the fixed holding ring 15.

A lens hood 2 is configured at the tip portion 16a of the barrel ring 16, capable of engagement/separation therewith in bayonet fashion. The lens hood 2 has a configuration such as shown in FIGS. 6 through 11. The lens hood 2 has a tubular portion 31, a perpendicular face portion 32, and a sun shade portion 33, with these formed integrally. The tubular portion 31 is a portion for bayonet-engagement with the tip portion 16a of the barrel ring 16, formed as a ring portion having a predetermined length in the axial direction. Two forward mounting regaining claws 34 are provided on the inner face of the tubular portion 31 at one side in the axial direction, and two reverse mounting retaining claws 35 are provided on the inner face of the tubular portion 31 at the other side in the axial direction.

Further, forward stopper protrusions 36 for preventing excessive insertion of the barrel ring 16 at the time of forward mounting are each provided to one side in the circumferential direction of the two forward mounting retaining claws 34 on the inner face of the tubular portion 31. In the same way, reverse stopper protrusions 37 for preventing excessive insertion of the barrel ring 16 at the time of reverse mounting are each provided to one side in the circumferential direction of the two reverse mounting retaining claws 35 on the inner face of the tubular portion 31. From one end of the forward mounting retaining claws 34 to the other end of the forward stopper protrusions 36 is approximately ¼ of the inner face region of the tubular portion 31, and an arc-shaped protrusion 41 of the barrel ring 16 is inserted into a gap region which is approximately ¼ at the opposite side thereof.

The forward mounting retaining claws 34 and the reverse mounting retaining claws 35 are similar, and with the present embodiment are formed by providing a V-shaped notch partway along a protrusion continuously raised in the circumferential direction. The two forward mounting retaining claws 34 are provided at a position turned 180 degrees in the circumferential direction, and in the same way, the reverse mounting retaining claws 35 are also at a position turned 180 degrees in the circumferential direction. Also, the forward mounting retaining claws 34 and reverse mounting retaining claws 35 are positioned at positions rotationally displaced by an appropriate angle in the circumferential direction (around 20 degrees with the present embodiment). The reason that the forward mounting retaining claws 34 and reverse mounting retaining claws 35 are positioned at positions rotationally displaced is primarily with regard to consideration for the mold for injection forming at the time of manufacturing the lens hood 2.

Also, the distance in the axial direction between the forward mounting retaining claws 34 and the reverse mounting retaining claws 35 in the tubular portion 31 is set to be a distance where attachment of the lens hood 2 to the barrel ring 16 can be performed without problem in both cases of forward mounting and reverse mounting. That is to say, the distance is such that at the time of performing forward mounting, the tip of the barrel ring 16 does not come into contact with the reverse mounting retaining claws 35, and at the time of performing reverse mounting, the tip of the barrel ring 16 does not come into contact with the forward mounting retaining claws 34. This distance is a distance where the tip of the barrel ring 16 does not pass the perpendicular face portion 32 in the axial direction (state in FIGS. 7 through 9) when performing bayonet attachment of the lens hood 2 to the barrel ring 16. By setting such a spacing distance, the tip of the barrel ring 16 can be prevented from coming into contact with the retaining claws situated at the subject side.

The perpendicular face portion 32 of the lens hood 2 is provided to the outer face of the tubular portion 31, at the generally middle portion in the axial direction, and is a flange part disposed on the outer side in the radial direction so as to be a perpendicular face orthogonal to the axial line of the tubular portion 31. Arc-shaped grooves 38 are provided to the tubular portion 31 extending in the circumferential direction of the outer face of the tubular portion 31 are provided, at the two portions corresponding to the forward mounting retaining claws 34 and reverse mounting retaining claws 35, as shown in FIG. 11. Each arc-shaped groove 38 is formed from the outer side of one forward mounting retaining claw 34 to the outer side of the other reverse mounting retaining claw 35, thereby providing elasticity to the portion of the tubular portion 31 with the forward mounting retaining claws 34 and reverse mounting retaining claws 35. This configuring the portion where there are the forward mounting retaining claws 34 and reverse mounting retaining claws 35 facilitates flexing deformation of the forward mounting retaining claws 34 and reverse mounting retaining claws 35, thereby improving the bayonet engagement capabilities and improving the clicking sensation at the time of engaging/disengaging.

The sun shade portion 33 of the lens hood 2 is formed in a petal-like form by V-shaped notches at four places on the circumferential direction. A tapered inclining face is provided at the base end of the sun shade portion 33, with the upper edge of the perpendicular face portion 32 being continued from the rear end of the inclining face. Examples of materials for the lens hood 2 having such a configuration include ABS (acrylonitrile butadiene styrene resin), ABS+PC (polycarbonate), PC-GF (fiberglass-reinforced polycarbonate), and so forth. However, POM (polyacetal) and other engineering plastics may also be used.

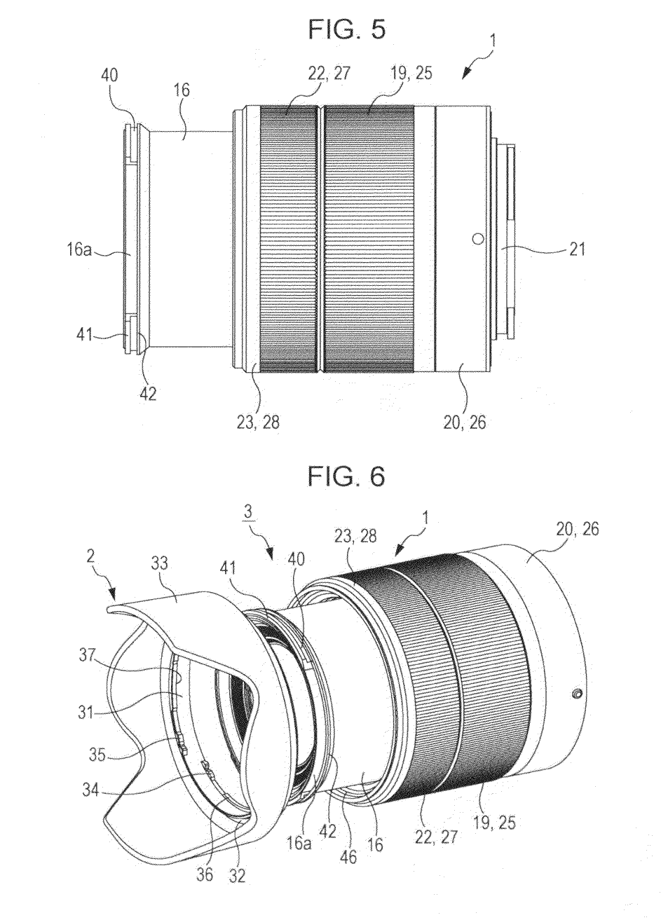

A hood mounting groove 40 is provided to the tip portion 16a of the barrel ring 16 corresponding to this lens hood 2, for bayonet engagement of the lens hood 2. The tip portion 16a of the barrel ring 16 has a form such as shown in FIGS. 5 and 6. Provided to the outer face of the tip portion 16a are the arc-shaped protrusion 41 situated on the tip side and a ring-shaped protrusion 42 situated at a position somewhat deeper than the tip, with the hood mounting groove 40 formed between the ring-shaped protrusion 42 and the arc-shaped protrusion 41. The arc-shaped protrusion 41 is formed as a region taking up approximately ¼ of the circumferential direction, with two thereof being provided rotationally displaced by 180 degrees. On the other hand, the ring-shaped protrusion 42 is formed as a protrusion continuous 360 degrees in the circumferential direction.

Upon inserting the tubular portion 31 of the lens hood 2 into the tip portion 16a of the barrel ring 16, the forward mounting retaining claw 34 and forward stopper protrusion 36 provided to one side of the tubular portion 31 or the reverse mounting retaining claw 35 or reverse stopper protrusion 37 provided to the other side come into contact with the front face of the ring-shaped protrusion 42. Accordingly, the lens hood 2 is positioned as to the barrel ring 16, and at this time, the forward mounting retaining claws 34 or reverse mounting retaining claws 35 face the opening which is opened at the side of the hood mounting groove 40. Rotating the lens hood 2 to the left or the right results in the forward mounting retaining claws 34 or reverse mounting retaining claws 35 entering the hood mounting groove 40, so that bayonet engagement is performed.

The tip portion 16a of the barrel ring 16 to which the lens hood 2 is detachably bayonet-engaged protrudes from the tip of the fixed holding ring 15 toward the subject side in the optical axis direction even when in a retracted state, as shown in FIG. 4. The front holding ring 23 is attached at the tip portion 15a of the fixed holding ring 15 so as to correspond to the tip portion 16a of the barrel ring 16. The front holding ring 23 is configured so as to be detachably mounted to the fixed holding ring 15 in bayonet fashion. The tip portion 15b of the fixed holding ring 15 to which the front holding ring 23 is to be fixed is formed with a slightly greater diameter than the diameter of the tip portion 16a of the barrel ring 16. Accordingly, in a state with the barrel ring 16 held by the fixed holding ring 15, the front holding ring 23 and focus operating ring 22 can be assembled to and separated from the fixed holding ring 15 from the subject side.

The front holding ring 23 is a member for preventing the focus operating ring 22 from coming loose at the subject side, and has a shape such as shown in FIGS. 4, 14, and so forth. The front holding ring 23 is formed of a ring-shaped member having an appropriate width and thickness, with an inner diameter portion 23a being provided to one side on the width direction of a middle large-diameter portion, and a small diameter portion 23b being provided to the other side in the width direction. Three bayonet grooves 44 are situated at equal intervals in the circumferential direction of the inner face of the front holding ring 23. The bayonet grooves 44 each have a axial direction groove 44a opening to the small diameter portion 23b side which is the one side in the width direction of the front holding ring 23, and a circumferential direction groove 44b continuously extending in the circumferential direction at the back of the bayonet grooves 44 lock claws 45 are provided at an intermediate portion of the circumferential direction groove 44b.

Also, the hood end storing portion 46 is provided on the inner face of the inner diameter portion 23a side of the front holding ring 23, with a recessed portion having a square cross-sectional from continuing in the circumferential direction. The hood end storing portion 46 is a space in which one end of the axial direction of the tubular portion 31 of the lens hood 2 mounted to the tip portion 16a of the barrel ring 16 can be stored. The front holding ring 23 is further firmly fixed to the fixed holding ring 15 using a stopper pin 50, in addition to the bayonet method using the bayonet grooves 44.

For bayonet engagement of the front holding ring 23, three bayonet engagement claws 51 are disposed at equal intervals in the circumferential direction of the outer face of the tip portion 15b of the fixed holding ring 15. The bayonet engagement claws 51 are formed of protrusions having a circumferential direction length so as to be capable of engaging the axial direction groove 44a of the bayonet grooves 44. Recessed portions 52 with which the lock claws 45 provided within the bayonet grooves 44 can detachably engage are provided at an intermediate portion in the circumferential direction of the bayonet engagement claws 51. The lock claws 45 enter the recessed portions 52, thereby locking the front holding ring 23 at a predetermined position of the fixed holding ring 15.

At a position of the top portion 15a of the fixed holding ring 15 that is deeper than the bayonet engagement claws 51 are provided a first sliding supporting portion 48 and a second sliding supporting portion 49 slidably supporting the inner face of the focus operating ring 22. Movement of the focus operating ring 22 in the deep side direction of the optical axis is restricted by the second sliding supporting portion 49. The focus operating ring 22 which is rotatably supported by the first sliding supporting portion 48 and second sliding supporting portion 49 is restricted from motion toward the front in the optical axis direction by the front holding ring 23.

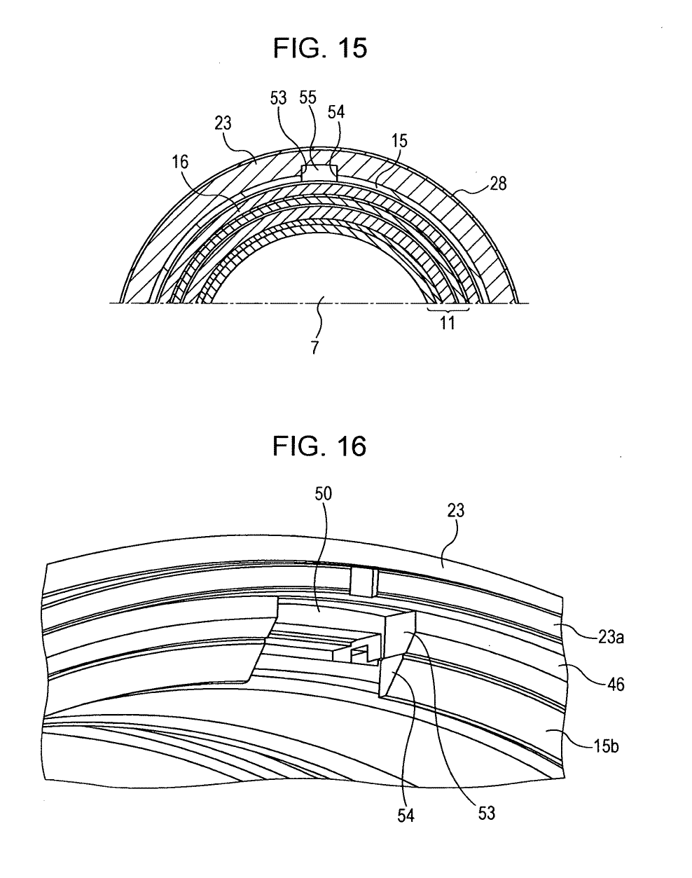

Also, as shown in FIG. 14, a fitting groove 53 into which the stopper pin 50 is fit, is provided on the inner face of the front holding ring 23. The fitting groove 53 is provided so as to communicate with one of the three bayonet grooves 44 provided to the front holding ring 23. The fitting groove 53 is opened to the hood end storing portion 46 provided to the inner diameter portion 23a of the front holding ring 23, and at the deep side thereof communicates with the base of the axial direction groove 44a of the bayonet grooves 44. Corresponding to the fitting groove 53, the corresponding position at the tip portion 15b of the fixed holding ring 15 is provided with a fitting recessed portion 54 into which a part of the stopper pin 50 is fit. As shown in FIGS. 15 and 16, a pin storage portion 55, where the stopper pin 50 which restricts relative rotation between the fixed holding ring 15 and the front holding ring 23 is stored, is configured by the fitting recessed portion 54 of the fixed holding ring 15 and the fitting groove 53 of the front holding ring 23.

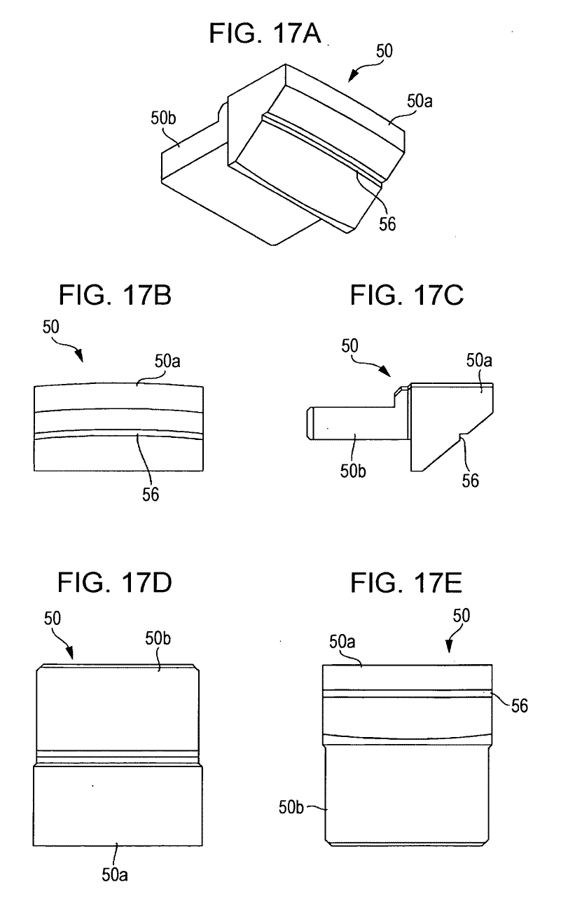

The stopper pin 50 has a shape such as shown in FIGS. 17A through 17E. The stopper pin 50 is of a shape corresponding to a part of the back part of the hood end storing portion 46 of the front holding ring 23, and has a front portion 50a formed in a wedge shape, and a fixed portion 50b formed integrally with the front portion 50a by protruding therefrom at the back side. The front portion 50a of the stopper pin 50 has a shape agreeing with the front side portion of the pin storage portion 55, and in a state of being mounted to the pin storage portion 55, the front face thereof is formed so as to be the same plane as the front face of the front holding ring 23 and the front face of the tip portion 15b of the fixed holding ring 15.

That is to say, the front portion 50a of the stopper pin 50 has a wedge shape with the lower portion retracted. The upper face of the front portion 50a is an arc-shaped curved face having the same curvature radius as the diameter of the hood end storing portion 46. Also, the front face of the front portion 50a is formed as a curved face forming a portion of a conical curved face. Provided to the front face of the front portion 50a is a decorative groove 56 continuing at the contact face between the fixed holding ring 15 and the front holding ring 23. The decorative groove 56 fits the fitting groove 53 of the front holding ring 23 upwards, and the decorative groove 56 fits the fitting recessed portion 54 of the fixed holding ring 15 below.

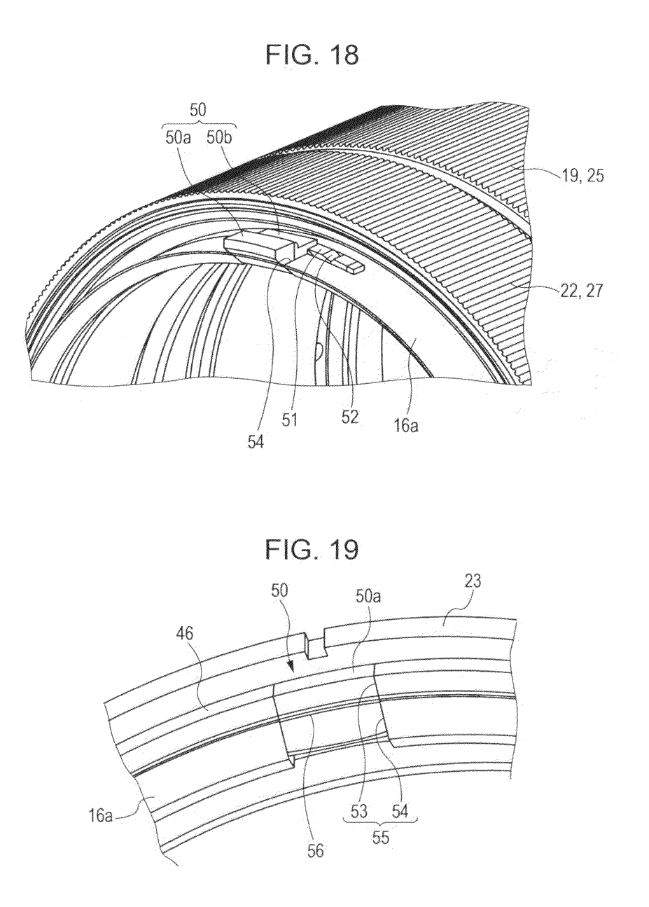

The fixed portion 50b of the stopper pin 50 is formed so as to protrude horizontally backwards from the generally middle portion in the height direction of the rear face of the front portion 50a. The fixed portion 50b is formed so as to overlap the contact face of the fixed holding ring 15 and the front holding ring 23, with the upper portion of the fixed portion 50b being pressed into the axial direction groove 44a of the bayonet grooves 44, and the lower portion of the fixed portion 50b pressed into a groove 15c of the fixed holding ring 15. FIG. 18 is a diagram illustrating a state in which the stopper pin 50 is mounted to the tip portion 15b of the fixed holding ring 15, the lower portion of the fixed portion 50b is pressed into the groove 15c of the tip portion 15b and fixed, and the lower portion of the front portion 50a is pressed into the fitting recessed portion 54 of the tip portion 15b and fixed.

Also, FIG. 19 is a diagram illustrating a state of having pressed the stopper pin 50 into the stopper pin 50 so as to be mounted. At this time, the front face of the stopper pin 50 is generally the same plane as the front face of the front holding ring 23 and the front face of the tip portion 15b of the fixed holding ring 15. The decorative groove 56 of the stopper pin 50 matches the contact face between the front holding ring 23 and the fixed holding ring 15.

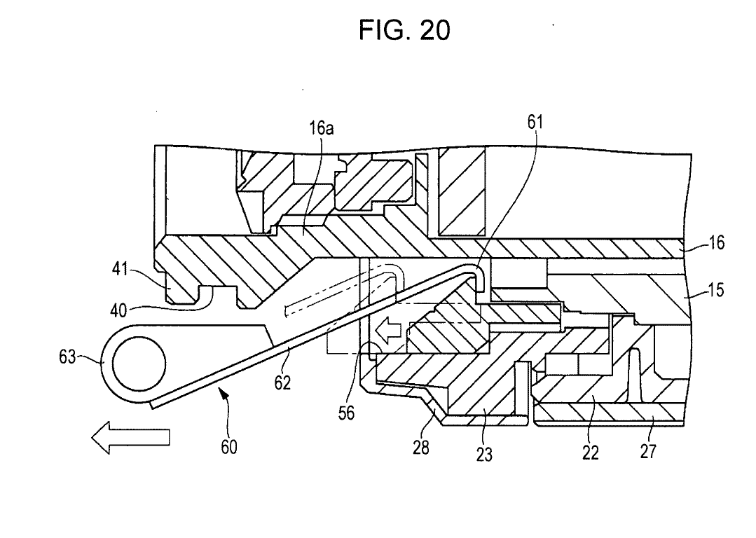

FIG. 20 is a diagram for describing a state of extracting the stopper pin 50 which has been fit to the pin storage portion 55. Extracting work of the stopper pin 50 can be performed using an extracting jig 60 such as shown in the drawing. The extracting jig 60 has an arm portion 62 with a hook portion 61 on the tip thereof, and a finger hold 63 formed continuously from the base of the arm portion 62.

AS shown in FIG. 20, in a state of the barrel ring 16 protruding, the hook portion 61 of the extracting jig 60 is inserted into the pin storage portion 55. The hook portion 61 at the tip is inserted into the internal space formed at the rear side of the front portion 50a of the stopper pin 50, so as to catch on the portion of the front portion 50a which resembles a jaw. From this state, the ringer is placed on the finger hold 63 of the extracting jig 60, and the extracting jig 60 is pulled out. Accordingly, the stopper pin 50 can be pulled out from the pin storage portion 55 against the holding force of the stopper pin 50 pressed into the pin storage portion 55.

AS for the material of the fixed holding ring 15, barrel ring 16, focus operating ring 22, front holding ring 23, and stopper pin 50, PC (polycarbonate) for example is suitable. However, it is needless to say that this is restricted to these materials, and that other engineering plastics may be used.

The assembly work of the front holding ring 23 with the stopper pin 50 can be performed as follows, for example. First, the focus operating ring 22 is fit into the subject side of the fixed holding ring 15, and the focus operating ring 22 is rotatably supported. Next, the front holding ring 23 is placed facing the front of the fixed holding ring 15, and the axial direction grooves 44a of the three bayonet grooves 44 provided to the front holding ring 23 are each placed facing the three bayonet engagement claws 51 provided to the tip portion 15b of the fixed holding ring 15. At this time, of the three bayonet grooves 44, the bayonet groove 44 communicating with the fitting groove 53 is positioned near the fitting recessed portion 54 of the tip portion 15b.

In this state, the front holding ring 23 is fit into the tip portion 15b, and the three bayonet engagement claws 51 are each fit to the axial direction grooves 44a of the three bayonet grooves 44. At this time, upon pressing in the front holding ring 23 to a certain depth, two bayonet engagement claws 51 come into contact with the base of the axial direction grooves 44a of two bayonet grooves 44, and accordingly, depth-wise positioning is performed. That is to say, the three bayonet engagement claws 51 each face the side of the circumferential direction grooved 44b of the three bayonet grooves 44.

Now, the front holding ring 23 is turned in the circumferential direction, so that the three bayonet engagement claws 51 are inserted into the three circumferential direction grooves 44b, making for bayonet engagement. At this time, the lock claw 45 provided within the circumferential direction groove 44b goes past the bayonet engagement claws 51 and enters the recessed portion 52, thereby the front holding ring 23 is locked to the fixed holding ring 15, and powerful fixing is ensured. At the same time, the fitting groove 53 of the front holding ring 23 matches the fitting recessed portion 54 of the tip portion 15b, forming the pin storage portion 55.

Now, the stopper pin 50 is fit into the pin storage portion 55. That is to say, the stopper pin 50 is inserted into the pin storage portion 55 from the fixed portion 50b, and inserted to a position where the front face of the front portion 50a is flush with the front face of the front holding ring 23 and the front face of the tip portion 15b. At this time, the stopper pin 50 is formed slightly larger than the pin storage portion 55, and is configured so as to be pressed into the pin storage portion 55 by the elasticity of the stopper pin 50 itself. Accordingly, the front holding ring 23 can be firmly fixed to the fixed holding ring 15 by the stopper pin 50 without using screws and without using adhesive agents.

In this case, the front holding ring 23 is firmly fixed to the fixed holding ring 15 in bayonet fashion, and so while this will not come loose under relatively small external force such as vibrations or the like, the bayonet engagement will come loose and rotate if rotated under a great force. However, with the arrangement described with the present embodiment, the stopper pin 50 is introduced between the front holding ring 23 and the fixed holding ring 15, thereby preventing relative rotational displacement of the front holding ring 23 as to the fixed holding ring 15. Accordingly, even in the event that rotation of the front holding ring 23 is attempted by a person applying great force, the rotation thereof is prevented in a sure manner, thereby preventing the bayonet engagement from coming loose in a sure manner.

Also, the front face of the stopper pin 50 is formed so as to be flush with the front faces of the front holding ring 23 and fixed holding ring 15. Moreover, the stopper pin 50 is set so as to be at a position on the inner side of the front holding ring 23 that is relatively difficult to see from the outside, there is no unnatural difference as to other parts, and the external appearance is not poor. Also, the removal work of the stopper pin 50 can be easily performed as described above, so replacement work of parts such as the focus operating ring 22 and so forth can be performed relatively easily. Note that assembly work of the barrel ring 16, zoom cam ring 17, fixed tube 18, and assembly work of the zoom operating ring 19, rear holding ring 20, and mount ring 21 and the like may be performed before the assembly work of the front holding ring 23 and so forth, or afterwards.

The lens hood 2 can be detachably mounted to the lens barrel 1 as follows for example, and at the time of mounting, the direction can be changed and forward mounting and reverse mounting can be optionally selected. FIGS. 1 through 4 illustrate a state in which the lens hood 2 is not attached to the lens barrel 1. In this state, the top portion 16a of the barrel ring 16 (the arc-shaped protrusion 41 in particular) is protruding forwards from the front holding ring 23 (more particularly, the front outer cover 28 mounted to the front holding ring 23). At this time, the hood end storing portion 46 provided to the front face of the front holding ring 23 is exposed at the front face of the lens barrel 1, and the hood end storing portion 46 is externally visible along with the hood mounting groove 40 provided to the tip portion 16a of the barrel ring 16.

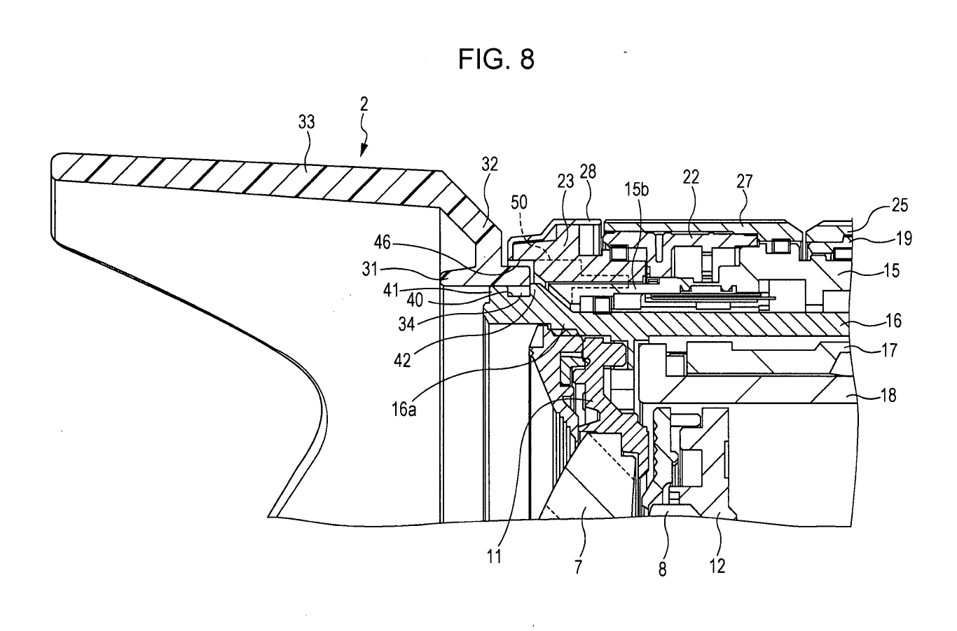

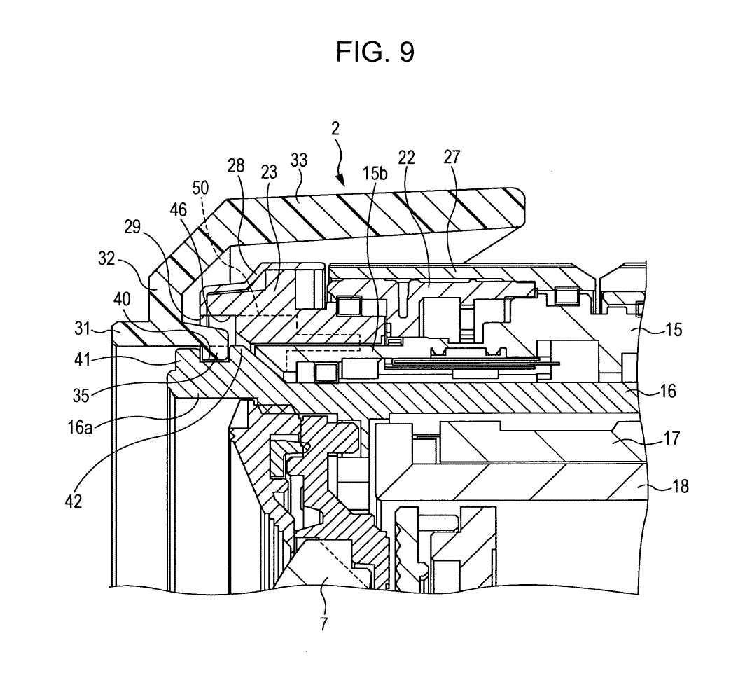

As shown in FIGS. 1 through 4, the attaching work of the lens hood 2 as to the lens barrel 1 can be performed in a retracted state with the barrel ring 16 retracted, but also can be performed in a state with the barrel ring 16 protruding in the optical axis direction, as shown in FIGS. 5 and 6. FIGS. 7 and 8 illustrate a state in which the lens hood 2 is forward-mounted to the hood mounting groove 40 in the retracted state of the lens barrel 1. Also, FIGS. 9 through 11 illustrate a state in which the lens hood 2 is inverse-mounted to the hood mounting groove 40 in the retracted state of the lens barrel 1.

First, description will be made regarding a case of forward mounting of the lens hood 2 to the lens barrel 1. In this case, the portion of the lens hood 2 which protrudes in the opposite direction of the tubular portion 31 as to the sun shade portion 33 is brought to face the tip portion 16a of the barrel ring 16. The two forward mounting retaining claws 34 provided on the inner face of the tubular portion 31 are brought to match portions without the two arc-shaped protrusions 41 provided on the outer face of the tip portion 16a. Next, with the forward mounting retaining claws 34 positioned at portions without the arc-shaped protrusions 41, the tubular portion 31 is inserted into the tip portion 16a, and the forward mounting retaining claws 34 are brought into contact with the ring-shaped protrusion 42. Accordingly, the depth position of the forward mounting retaining claws 34 matches the hood mounting groove 40.

Now, by rotating the lens hood 2, the forward mounting retaining claws 34 move in the circumferential direction and enter into the hood mounting groove 40, so that the lens hood 2 is bayonet-engaged. At this time, the forward mounting retaining claws 34 are provided on an elastic piece to which elasticity has been provided by providing the arc-shaped grooves 38 to the perpendicular face portion 32 of the lens hood 2. Accordingly, upon the forward mounting retaining claws 34 entering into the hood mounting groove 40, the forward mounting retaining claws 34 are supported by pressing force within the range of elastic deformation of the elastic pieces. Consequently, the lens hood 2 is hold in a sure manner by appropriate tightening force.

At this time, as shown in FIGS. 7 and 8, the end portion of the forward mounting retaining claws 34 of the tubular portion 31 protruding from one side of the perpendicular face portion 32 of the lens hood 2 enter into the hood end storing portion 46 provided to the front holding ring 23, and are not eternally visible. Accordingly, the edge of the tubular portion 31 at the forward mounting retaining claw 34 side can be prevented from being scratched by external force. Also, the tip of the front outer cover 28 is in close proximity to the perpendicular face portion 32, so the edge of the tubular portion 31 at the forward mounting retaining claw 34 side and the tip portion 16a of the barrel ring 16 is completely hidden from external view. Accordingly, even in the event that the edge of the tubular portion 31 and the tip portion 16a of the barrel ring 16 are scratched due to external force applied during bayonet engagement or separation for example, the scratches can be hidden and external appearance improved. At this time, the edge of the tubular portion 31 at the reverse mounting retaining claws 35 side is situated on the inner side of the sun shade portion 33 of the lens hood 2, so this portion is not externally exposed.

Next, description will be made regarding a case of reverse mounting of the lens hood 2 to the lens barrel 1. This case is also generally the same as with the case of forward mounting, the difference being that the portion of the lens hood 2 which protrudes in the sun shade portion 33 side direction of the tubular portion 31 is brought to face the tip portion 16a of the barrel ring 16. Other mounting work is the same as with the work when forward mounting.

That is to say, the two reverse mounting retaining claws 35 provided on the inner face of the tubular portion 31 are brought to match portions without the two arc-shaped protrusions 41 provided on the outer face of the tip portion 16a, the tubular portion 31 is inserted into the tip portion 16a in this state, and the two reverse mounting retaining claws 35 are brought into contact with the ring-shaped protrusion 42. Accordingly, the depth position of the reverse mounting retaining claws 35 matches the hood mounting groove 40. Now, by rotating the lens hood 2, the two reverse mounting retaining claws 35 move in the circumferential direction and enter into the hood mounting grooves 40, 40, so that the lens hood 2 is bayonet-engaged.

At this time, as shown in FIG. 9, the reverse mounting retaining claws 35 are provided with elasticity by the arc-shaped grooves 38 provided to the perpendicular face portion 32, and the reverse mounting retaining claws 35 are provided on the elastic pieces. Accordingly, upon the reverse mounting retaining claws 35 entering into the hood mounting groove 40, the reverse mounting retaining claws 35 are supported by pressing force within the range of elastic deformation of the elastic pieces. Consequently, the lens hood 2 is hold in a sure manner by appropriate tightening force in a sure manner at the tip portion 16a of the barrel ring 16.

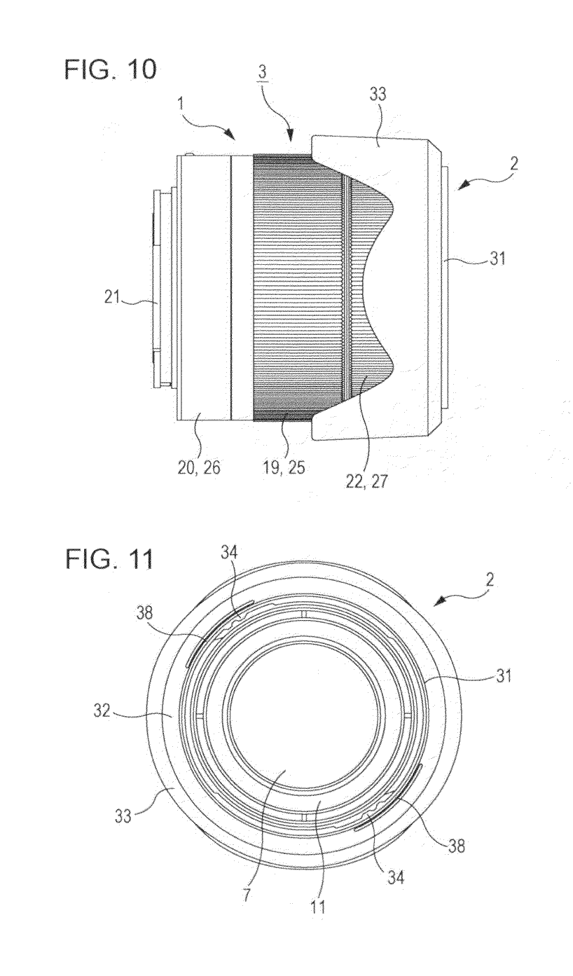

With this reverse mounted state, as can be seen from FIGS. 9 and 10, the hood end of the tubular portion 31 at the forward mounting retaining claws 34 side protrudes forward in the optical axis direction beyond the tip portion 16a of the barrel ring 16. Accordingly, due to the hood end being the farthest tip, the hood tip is in the state most likely to be scratched, and may be scratched when carrying. However, the tip portion 16a of the barrel ring 16 is stored on the inner side of the tubular portion 31 of the lens hood 2, and is not externally visible. Accordingly, even if external force is applied to the hood end when carrying, the shock applied to the tip portion 16a of the barrel ring 16 can be reduced and effects of external force can be reduced. Accordingly, the risk of the tip portion 16a of the barrel ring 16 being scratched can be alleviated.

### Second Embodiment

FIG. 21 is an external perspective view of a single-lens reflex type digital still camera (hereinafter referred to as “digital still camera”) 5 according to a second embodiment of the present invention. The second embodiment is an imaging apparatus which can use a lens device according to the first embodiment. This digital still camera 5 is configured having a camera body main unit 4 formed of a casing which is longer in the horizontal direction, and the lens device 3 detachably attached to the camera body main unit 4 and so forth.

The camera body main unit 4 is made up of a hollow casing which is longer in the horizontal direction, with wiring boards to which various types of electronic parts are mounted, a battery power source, storage device, other various types of electronic parts and mechanical parts, devices, and the like being stored in the space therein, though not shown in the drawings. A mount portion 72 to which the lens device 3 is detachably mounted is provided at the generally middle portion of the front face of the camera body main unit 4. Also, a grasping portion 73 is provided at the right side of the front face of the camera body main unit 4 for grasping the camera body main unit 4. The grasping portion 73 is formed with the front face of the camera body main unit 4 protruding forwards, so as to be easy to hold with one hand.

A flash device 74 which emits illumination light toward the subject is disposed on the generally meddle portion of the upper face of the camera body main unit 4. The flash device 74 is configured as a pop-up type built-in flash, and can be switched between a state of being laid down which is illustrated, and a state of being popped up upwards which is not illustrated. Further, a shutter button 75 for photographing the subject is provided at the grasping portion 73 side on the upper face of the camera body main unit 4.

Also, on the opposite side of the camera body main unit 4 from the grasping portion 73, on the upper face thereof, is provided a mode selection dial 76. The mode selection dial 76 is a rotary switch for selecting a desired function mode from a great number of camera functions provided to the digital still camera 5. Examples of various functions selected with the mode selection dial 76 include a mode for shooting still images, a mode for shooing moving images, a mode for playing and editing the shot images, and so forth.

Provided on the rear face of the camera body main unit 4 are an electronic viewfinder 77 and an unshown display, such as flat display panel formed of a liquid crystal display (LCD) or the like. Further, various types of switches for selecting various types of camera functions are provided around the flat display panel.

The lens barrel 1 can be attached to the camera body main unit 4 having such a configuration, and the lens hood 2 mounted to the lens barrel 1, so as to be used as a digital still camera 5 with a lens hood. With this digital still camera 5, excessive incident light to the lens barrel 1 can be prevented by the lens hood 2, so better images of the subject can be taken.

With the present embodiment, as shown in FIGS. 7 and 8, a configuration is employed with a hood end storing portion for storing the end portion of the lens hood provided at the top portion of the barrel ring, so the end thereof can be covered when using the lens hood. As a result, the end of the hood which is readily scratched can be covered so, unsightly portions are not readily seen, making the external appearance of the exchangeable lens more appealing. Accordingly, the hold end portion and hood mounting groove which make for unsightly portions can be stored in the hood end storing portion, thereby hiding the unsightly portions, and a lens devices with good external appearance can be provided.

The present invention is not restricted to the above-described and illustrated embodiments, and various modifications can be made without departing from the spirit thereof. For example, while an example has been described in the above embodiments of a case of applying a digital still camera as the imaging apparatus, this is also applicable to other imaging apparatuses such as digital video cameras, film single-lens reflex cameras, analog cameras, analog video cameras, surveillance cameras, and so forth. Further, a case wherein a three-group lens is used as the optical lens has been described, but it is needless to say that this may be a four-group lens, five-group lens, or higher.

The present application contains subject matter related to that disclosed in Japanese Priority Patent Application JP 2010-108802 filed in the Japan Patent Office on May 10, 2010 and Japanese Priority Patent Application JP 2010-108800 filed in the Japan Patent Office on May 10, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A lens barrel comprising:
a barrel ring fixedly or movably supporting a plurality of lenses arrayed in an optical axis direction;
a first holding ring movably holding said barrel ring in said optical axis direction;
an operating ring rotatably supported by said first holding ring;
a second holding ring which prevents said operating ring from coming loose, by bayonet engagement with said first holding ring; and
a stopper pin, which is introduced between said first holding ring and said second holding ring, to prevent relative rotational displacement.

2. The lens barrel according to claim 1, wherein a pin storage portion is formed at a portion where said first holding ring and said second holding ring come into contact, with both said first holding ring and said second holding ring having a recessed portion thereat;
and wherein said stopper pin is detachably press-fit into said pin storage portion.

3. The lens barrel according to claim 1, said lens hood further including a bayonet retaining claw;
wherein a hood mounting groove for bayonet engagement is provided on the circumferential face on the tip portion of said barrel ring;
and wherein a hood end storage portion capable of storing a portion where the lens hood, bayonet-engaged with said hood mounting groove, has the bayonet retaining claw.

4. The lens barrel according to claim 3, wherein said hood end storage portion is formed of a ring-shaped notched portion that is continuously formed in the circumferential direction on the front face of said second holding ring.

5. An imaging apparatus comprising:
a lens barrel having a plurality of lenses; and
an imaging apparatus to which said lens barrel is detachably mounted;
said lens barrel including
a barrel ring fixedly or movably supporting a plurality of lenses arrayed in an optical axis direction,
a first holding ring movably holding said barrel ring in said optical axis direction,
an operating ring rotatably supported by said first holding ring, and
a second holding ring which prevents said operating ring from coming loose, by bayonet engagement with said first holding ring;
wherein a stopper pin is introduced between said first holding ring and said second holding ring, to prevent relative rotational displacement.

6. A lens device comprising:
a lens unit including
a barrel ring with a hood mounting groove formed on the outer face of the tip end side, and
a front holding ring disposed concentrically with said barrel ring; and
a lens hood including
retaining claws formed on the inner face thereof, detachably engaged with said hood mounting groove, and
a tubular portion into which the tip end side of said barrel ring is inserted;
said tubular portion further including
forward mounting retaining claws provided on one side in the axial direction of the inner face of said tubular portion, and
reverse mounting retaining claws provided on the other side in the axial direction of the inner face of said tubular portion;
wherein a hood end storage portion, capable of storing one side or the other side of said tubular portion of said lens hood mounted to said hood mounting groove, is provided to said front holding ring.

7. The lens device according to claim 6, said lens hood further including a perpendicular face portion disposed from the outer face of said tubular portion to the outer side in the radial direction;
wherein said tubular portion is formed such that both end portions protrude from both faces of said perpendicular face portion in both sides in said axial direction;
and wherein, when said retaining claws are engaged with said hood mounting groove, the tip end of said barrel ring does not exceed said perpendicular plan portion in the axial direction.

8. The lens device according to claim 6, wherein said hood end storage portion is formed of a ring-shaped notched portion that is continuously formed in the circumferential direction on the front face of said front holding ring.

9. An imaging apparatus comprising:
a lens unit including
a barrel ring with a hood mounting groove formed on the outer face of the tip end side, and
a front holding ring disposed concentrically with said barrel ring;
a lens hood including
retaining claws formed on the inner face thereof, detachably engaged with said hood mounting groove, and
a tubular portion into which the tip end side of said barrel ring is inserted;
said tubular portion further including
forward mounting retaining claws provided on one side in the axial direction of the inner face of said tubular portion, and
reverse mounting retaining claws provided on the other side in the axial direction of the inner face of said tubular portion; and
an imaging apparatus main unit to which said lens unit is detachably mounted;
wherein a hood end storage portion, capable of storing one side or the other side of said tubular portion of said lens hood mounted to said hood mounting groove, is provided to said front holding ring.

10. A lens hood comprising:
a tubular portion into which the tip end side of a barrel ring of a lens unit is inserted; and
a hood shielding portion formed integrally with and continuously from the outer face of said tubular portion, and spreading out in one side of the axial direction of said tubular portion;
said tubular portion further including
forward mounting retaining claws mounted to a hood mounting groove provided to the outer face of said barrel ring, provided on one side in the axial direction of the inner face of said tubular portion, and
reverse mounting retaining claws provided on the other side in the axial direction of the inner face of said tubular portion;
wherein said tubular portion protrudes in both sides in said axial direction from a perpendicular face direction disposed in a direction perpendicular to said axial direction;
and wherein said tubular portion is formed such that, when said retaining claws are engaged with said hood mounting groove, the tip end of said barrel ring does not exceed said perpendicular face portion in the axial direction.
